(19) United States
(12) Patent Application Publication
(10) Pub. No.: US 2007/0099299 A1
(43) Pub. Date: May 3, 2007

(54) Catalyst support, catalyst and process for dehydrogenating hydrocarbons

(75) Inventors: Falk Simon, Bensheim (DE); Sven Crone, Limburgerhof (DE); Gotz-Peter Schindler, Mannheim (DE); Ulrich Muller, Neustadt (DE); Frank Stallmach, Markkleeberg (DE); Wiete Schonfelder, Leipzig (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/523,016

(22) Filed: Sep. 19, 2006

Related U.S. Application Data
(63) Continuation of application No. 60/718,295, filed on Sep. 20, 2005.

(30) Foreign Application Priority Data
Sep. 20, 2005 (DE) 102005044916.6

(51) Int. Cl. G01N 31/10

(52) U.S. Cl. 436/37

(57) ABSTRACT

Catalyst supports and catalysts comprising them, having a certain tortuosity, and their use for heterogeneously catalyzed dehydrogenations of hydrocarbons.

The invention relates to a catalyst support, to a dehydrogenation catalyst and to a process for heterogeneously catalyzed dehydrogenation of C₂-C₃₀ hydrocarbons, preferably of C₂-C₁₅ hydrocarbons, more preferably of C₂-C₈ hydrocarbons and most preferably of C₃ and C₄ hydrocarbons. Hydrocarbons are preferably understood to mean chemical compounds which are composed exclusively of C and H. Particularly advantageous is the inventive heterogeneously catalyzed dehydrogenation of saturated hydrocarbons. The invention further relates to a process for determining the tortuosity of a porous catalyst support.

Dehydrogenated hydrocarbons are required in large amounts as starting materials for numerous industrial processes. For example, dehydrogenated hydrocarbons find use in the preparation of detergents, knock-resistant gasoline and pharmaceutical products. Numerous plastics are likewise prepared by polymerization of olefins.

For example, acrylonitrile, acrylic acid or C₄ oxo alcohols are prepared from propylene. Propylene is currently prepared predominantly by steamcracking or by catalytic cracking of suitable hydrocarbons or hydrocarbon mixtures such as naphtha.

Propylene can additionally be prepared by heterogeneously catalyzed dehydrogenation of propane.

In order to achieve acceptable conversions in heterogeneously catalyzed dehydrogenations even with single reactor pass, it is generally necessary to operate at relatively high reaction temperatures. Typical reaction temperatures for heterogeneously catalyzed gas phase dehydrogenations are from 300 to 700° C. One molecule of hydrogen is generally obtained per molecule of hydrocarbon.

The dehydrogenation of hydrocarbons proceeds endothermically (a downstream or simultaneous combustion of the hydrogen formed can ensure thermal compensation). The heat of dehydrogenation required for the attainment of a desired conversion either has to be supplied to the reaction gas beforehand and/or in the course of the catalytic dehydrogenation. In most known dehydrogenation processes, the heat of dehydrogenation is generated outside the reactor and supplied to the reaction gas from outside. This entails complicated reactor and process designs and leads to steep temperature gradients in the reactor at high conversions, with the risk of enhanced by-product formation. For example, a plurality of adiabatic catalyst beds can be arranged in annular gap reactors connected in series. The reaction gas mixture is superheated by heat exchangers on its way from one catalyst bed to the next catalyst bed and is cooled again in the next reactor pass. In order to obtain high conversions with such a reactor design, the number of the reactors connected in series or the reactor inlet temperature of the gas mixture has to be increased. The overheating that this causes leads inevitably to enhanced by-product formation as a result of cracking reactions. Also known is the arrangement of the catalyst bed in a tubular reactor and the generation of the heat of dehydrogenation by the firing of combustible gases outside the tubular reactor and the introduction into the interior of the reactor through the tube wall. In these reactors, high conversions lead to steep temperature gradients between the wall and the interior of the reaction tube.

One alternative is the generation of the heat of dehydrogenation directly in the reaction gas mixture for the dehydrogenation by oxidation of hydrogen formed in the dehydrogenation or additionally supplied, or of hydrocarbons present in the reaction gas mixture, with oxygen. To this end, an oxygenous gas and, if appropriate, hydrogen are added to the reaction gas mixture either upstream of the first catalyst bed or upstream of the subsequent catalyst beds. The heat of reaction released in the oxidation also prevents large temperature gradients in the reactor in the case of high conversions. Simultaneously, dispensing with indirect reactor heating realizes a very simple process design.

Catalysts for heterogeneously catalyzed dehydrogenations are normally solids which consist of an inert substrate (support) and of an active composition applied to it (especially to its inner surface). They are also referred to as supported catalysts. The support normally differs from the active composition in that it is not capable of catalyzing the dehydrogenation. In other words, the dehydrogenation conversions achieved in its presence and in its absence under otherwise identical dehydrogenation conditions (in mol % of the starting compound) are typically different from one another by less than 5 mol %, preferably by less than 3 mol % and more preferably by less than 1 mol %.

U.S. Pat. No. 4,788,371 describes a process for steam dehydrogenation of dehydrogenatable hydrocarbons in the gas phase in conjunction with oxidative reheating of intermediates, the same catalyst being used for the selective oxidation of hydrogen and the steam dehydrogenation. In this process, hydrogen may be supplied as a cofeed. The catalyst used comprises a noble metal of group VIII, an alkali metal and a further metal from the group of B, Ga, In, Ge, Sn and Pb on an inorganic oxide support such as aluminum oxide. The process may be carried out in one or more stages in a fixed bed or moving bed.

WO 94/29021 describes a catalyst which comprises a support consisting substantially of a mixed oxide of magnesium and aluminum Mg(Al)O, and also a noble metal of group VIII, preferably platinum, a metal of group IVA, preferably tin, and if appropriate an alkali metal, preferably cesium. The catalyst is used in the dehydrogenation of hydrocarbons, and it is possible to work in the presence of oxygen.

U.S. Pat. No. 5,733,518 describes a process for selectively oxidizing hydrogen with oxygen in the presence of hydrocarbons such as n-butane over a catalyst comprising a phosphate of germanium, tin, lead, arsenic, antimony or bismuth, preferably tin. The combustion of the hydrogen generates the heat of reaction needed for the endothermic dehydrogenation in at least one reaction zone.

EP-A 0 838 534 describes a catalyst for the steam-free dehydrogenation of alkanes, especially of isobutane, in the presence of oxygen. The catalyst used comprises a platinum group metal which has been applied to a support composed of tin oxide/zirconium oxide with at least 10% tin. The oxygen content in the feed stream of the dehydrogenation is adjusted such that the amount of heat generated by combustion of hydrogen with oxygen is equal to the amount of heat required for the dehydrogenation.

WO 96/33151 describes a process for dehydrogenating a C₂-C₅ alkane in the absence of oxygen over a dehydrogenation catalyst comprising Cr, Mo, Ga, Zn or a group VIII metal with simultaneous oxidation of hydrogen formed over a reducible metal oxide such as the oxides of Bi, In, Sb, Zn, Tl, Pb or Te. The dehydrogenation has to be interrupted regularly in order to reoxidize the oxide reduced with an oxygen source again. U.S. Pat. No. 5,430,209 describes a corresponding process in which the dehydrogenation step and the oxidation step proceed in succession and the accompanying catalysts are spatially separated from one another. The catalysts used for the selective hydrogen oxidation include oxides of Bi, Sb and Te, and also their mixed oxides.

Finally, WO 96/33150 describes a process in which, in a first stage, a C₂-C₅-alkane is dehydrogenated over a dehydrogenation catalyst, the exit gas of the dehydrogenation stage is mixed with oxygen and, in a second stage, passed over an oxidation catalyst, preferably Bi₂O₃, which oxidizes the hydrogen formed selectively to water, and, in a third stage, the exit gas of the second stage is passed again over a dehydrogenation catalyst.

U.S. Pat. No. 5,565,775 describes a process for disruption-free determination of bound and free, i.e. producible, liquid fractions in porous materials (especially in deposits of rock), which is based on a two-component analysis of the self-diffusion behavior, measured with a pulsed field gradient (PFG) NMR technique, of the pore liquids enclosed in the pore space.

The catalyst system used has to satisfy high demands with regard to achievable alkane conversion, selectivity for the formation of alkenes, mechanical stability, thermal stability, carbonization behavior, deactivation behavior, regenerability, stability in the presence of oxygen and insensitivity toward catalyst poisons such as CO, sulfur- and chlorine-containing compounds, alkynes, etc., and economic viability.

It is an object of the invention to provide dehydrogenation catalysts having improved properties. It is a particular object of the invention to provide dehydrogenation catalysts with improved deactivation behavior.

The object is achieved by a catalyst support composed of a support material with a tortuosity characteristic τ of from 1.5 to 4, preferably from 1.5 to 3 and more preferably from 2 to 3. Appropriately, this tortuosity characteristic in this document, unless explicitly stated otherwise, relates to a determination at 25° C. and 1 bar using H₂O as a probe molecule. This is because H₂O is capable of simulating the diffusion behavior of the relevant reactants in good approximation.

However, particular preference is given in accordance with the invention to catalyst supports whose tortuosity characteristic determined with the hydrocarbon (for example propane or a butane such as isobutane) to be dehydrogenated at 25° C. and 1 bar is 1.5-4, preferably 1.5-3, more preferably 2-3. Very particular preference is given to catalyst supports whose tortuosity characteristic, determined with the hydrocarbon to be dehydrogenated, but at the temperature employed for the dehydrogenation and the pressure employed for the dehydrogenation, is 1.5-4, preferably 1.5-3, more preferably 2-3.

Even more advantageous are catalyst supports whose tortuosity characteristic determined with the unsaturated hydrocarbon (for example propene or a butene, for example isobutene) formed by the dehydrogenation at 25° C. and 1 bar is 1.5-4, preferably 1.5-3, more preferably 2-3. Very particular preference is given to catalyst supports whose tortuosity characteristic, determined with the unsaturated hydrocarbon formed by the dehydrogenation, but at the temperature employed for the dehydrogenation and the pressure employed for the dehydrogenation, is 1.5-4, preferably 1.5-3, more preferably 2-3.

With regard to the support geometry, there are no restrictions in accordance with the invention. Particularly frequent geometries are solid cylinders, hollow cylinders (rings), spheres, cones, pyramids and cubes. The different geometries may be obtained, for example, by tableting or extrusion. Extrusion is especially suitable for forming extrudates, wagonwheels, stars, monoliths or rings. Spalled supports (support spall) may be used. The longitudinal dimension (longest direct line connecting two points on the support surface) of such supports is in many cases from 0.5 mm to 100 mm, often from 1.5 mm to 80 mm and in many cases from 3 mm to 50 mm, or to 20 mm. For support spheres for catalysts to be used in fluidized bed reactors, this longitudinal dimension is appropriately from 0.01 mm to 1 mm, preferably from 0.02 to 0.2 mm. For monoliths and foams which are used, for example, advantageously in low-pressure drop reactors, this longest dimension may be up to 1000 mm.

This object is also achieved by a dehydrogenation catalyst comprising one or more active compositions on a catalyst support (especially on its inner surface by appropriate impregnation) composed of a support material with an aforementioned tortuosity characteristic (determined with water, or the hydrocarbon to be dehydrogenated, or the unsaturated hydrocarbon formed in the dehydrogenation) τ of from 1.5 to 4, preferably 1.5-3, more preferably 2-3. The active composition generally comprises at least one active metal in elemental form, but may also be exclusively of oxidic nature.

### BRIEF DESCRIPTION OF THE DRAWINGS

FIG. 1A is a pulse program for the generation of spin echo NMR signals;

FIG. 1B is a second pulse program for the generation of spin echo NMR signals;

FIG. 1C is a third pulse program for the generation of spin echo NMR signals; and

FIG. 2 is a graph showing the best line fit of mean quadratic shift as a function of diffusion time for catalyst supports 1 to 7.

In a further aspect of the invention, the tortuosity characteristic τ of a catalyst support material is determined by determining the self-diffusion D (self-diffusion coefficient, referred to hereinafter as “self-diffusion” for short) of a probe gas or of a probe liquid in the support material and the self-diffusion D₀ of the free gas or of the free liquid as a quotient τ=D/D₀ under the appropriate boundary conditions (25° C., 1 bar) (see below).

A free gas or a free liquid is understood to mean a gas or a liquid whose expansion is much greater than the mean free path length of the molecules and for which surface effects can be disregarded relative to their expansion.

Preferred inventive supports for dehydrogenation catalysts comprise, as a support material, a metal oxide, for example selected from the group consisting of zirconium dioxide, aluminum oxide, silicon dioxide, titanium dioxide, magnesium oxide, lanthanum oxide and cerium oxide, and mixtures thereof. The mixtures may be physical mixtures or else chemical mixed phases such as magnesium aluminum oxide or zinc aluminum oxide mixed oxides. In principle, useful support materials are both metal oxides per se (for example those mentioned above) and mixtures of metal oxides or mixed metal oxides. Dehydrogenation catalysts particularly suitable in accordance with the invention comprise, on the inventive support, at least one element of transition group VIII, or at least one element of main group I or II, or at least one element of main group III or IV, or at least one element of transition group III, including the lanthanides and actinides, in each case in metallic and/or chemically bound form.

Very particularly preferred dehydrogenation catalysts comprise, on the inventive support, at least one element of transition group VIII, at least one element of main group I and/or II, at least one element of main group III and/or IV and at least one element of transition group III, including the lanthanides and actinides, in metallic or chemically bound form. Among the aforementioned elements, the elements of transition group VIII and of main group IV are preferably present in elemental form and the remaining elements in oxidic form.

The invention further provides a process for heterogeneously catalyzed dehydrogenation of one or more dehydrogenatable C₂-C₃₀ hydrocarbons, preferably one or more C₂-C₁₅ hydrocarbons, more preferably one or more C₂-C₈ hydrocarbons and most preferably one or more C₃ and C₄ hydrocarbons, in a reaction gas mixture comprising them, in which the reaction gas mixture which comprises the dehydrogenatable hydrocarbon(s) is contacted with at least one inventive dehydrogenation catalyst.

It has been found that catalysts based on the inventive catalyst supports with the specified tortuosity have particularly favorable deactivation behavior, i.e. are deactivated particularly slowly during the reaction.

The tortuosity characteristic (or the “labyrinth factor”) of a porous material corresponds to a good approximation of the square of the ratio of the length (L) of the shortest connection between two points in the pore space, which passes entirely through the pore space, to the geometric separation of these points (L₀) (equation 1):

$$τ ≡ {( \frac{L}{{L}_{0}} )}^{2} \geq 1 , \qquad ( 1 )$$

where the geometric separation of the points is large compared to characteristic dimensions of the pore space, for example pore or particle diameter. It follows from this that the tortuosity of a porous material is greater than or equal to 1.

For transport processes which proceed through the pore space, the tortuosity describes the square of the extension of the transport path as a result of the geometric hindrance at the pore/matrix interface. In addition to the porosity (φ), the tortuosity thus constitutes an important parameter which determines the transport parameters in porous materials. In transport diffusion processes, it is expected, for example, that the diffusion coefficient of a fluid in the porous material (D_{t,eff}) is reduced by the quotient of porosity and tortuosity in comparison to the free fluid (Dₜ) (equation 2):

$${D}_{t , eff} = \frac{Φ}{τ} {D}_{t} \qquad ( 2 )$$

When the self-diffusion of liquids in the pore space is observed over distances which are large compared to the pore size, it is found that the self-diffusion coefficient in the pore space (D) in comparison to the value which is measured in the free liquid (D₀) is reduced precisely by the tortuosity (equation 3):

$$D = \frac{1}{τ} {D}_{0} \qquad ( 3 )$$

The self-diffusion coefficient of the free liquid D₀ and the same liquid in a porous material D can be measured directly, for example, by means of PFG NMR (pulsed field gradient nuclear magnetic resonance). Alternatively, it is also possible to use tracers (for example radioactive tracers). The D₀/D ratio then gives the tortuosity of the porous material.

The greater the tortuosity of the transport pores in the catalyst particles, the longer is the time needed by reactant and by product molecules to exchange by means of diffusion between the catalytically active sites on the pore/matrix interface of the catalyst particles and the reaction medium flowing around the catalyst particles.

$${t}_{r / p} = τ \cdot \frac{{R}^{2}}{15 {D}_{r / p}} \qquad ( 4 )$$

When the residence time of reactant and product molecules in the catalyst particles has an influence on the catalytic properties, for example selectivity, activity and deactivation behavior, changes in the tortuosity of the transport pore system of the catalyst particles can lead to changes in the catalytic properties with otherwise identical properties of the catalyst matrix. The reason for this is the influence of the tortuosity on the mean residence time t_{r/p} of the reactant and product molecules, which can be estimated from the diffusion coefficient under reaction conditions (D_{r/p}) and the radius R of spherical catalyst particles (equation 4):

For nonspherical (for example cylindrical) catalyst particles, R in equation (4) designates the corresponding equivalent radius.

Advantageous in accordance with the invention are therefore dehydrogenation catalysts in which the active composition has been applied to the inner surface of the support such that the tortuosity of the finished catalyst corresponds substantially to that of the support used. Preferred catalysts are therefore also those having corresponding tortuosity characteristics (determined with water or the hydrocarbon to be dehydrogenated or the unsaturated hydrocarbon formed in the dehydrogenation) of 1.5-4, preferably 1.5-3, more preferably 2-3.

PFG NMR enables the destruction-free examination of self-diffusion, i.e. the thermally excited Brownian molecular motion of free gases and liquids, of macromolecular solutions and melts and of adsorbed molecules and liquids in the pore space of porous materials. It is a prerequisite that the molecules of the substances to be examined (gases or liquids) have, in their molecular structure, at least one atom with a non-vanishing nuclear spin I, and transitions between the Zeeman energy level of the nuclear spin I in a strong external magnetic field (B₀) can thus be observed with magnetic nuclear spin resonance (NMR).

The principle, performance and application of PFG NMR measurements are described in the references which follow: (1) E. O. Stejskal, J. E. Tanner, J. Chem. Phys. 42, 288-292 (1965); (2) Stallmach, F., Seiffert, G., Kärger, J., Kaess, U., and Majer, G., J. Magn. Reson. 151, 260-268 (2001); (3) Kärger, J., Papadakis, Ch. M., and Stallmach, F., Structure Mobility Relations of Molecular Diffusion in Interface Systems, in Lecture Notes in Physics, vol. 634, Editors: R. Stanarius, A. Pöppel, R. Haberlandt and D. Michel, Springer Verlag, 2004; (4) Stallmach, F., and Kärger, J., Adsorption 5, 117-133 (1999); (4) Kärger, J., and M. D. Ruthven, Diffusion in Zeolites and other Microporous Solids, Wiley-Interscience, New York, 1992 and Callaghan, P. T., Principles of Nuclear Magnetic Resonance Microscopy, Clarendon Press, Oxford 1991.

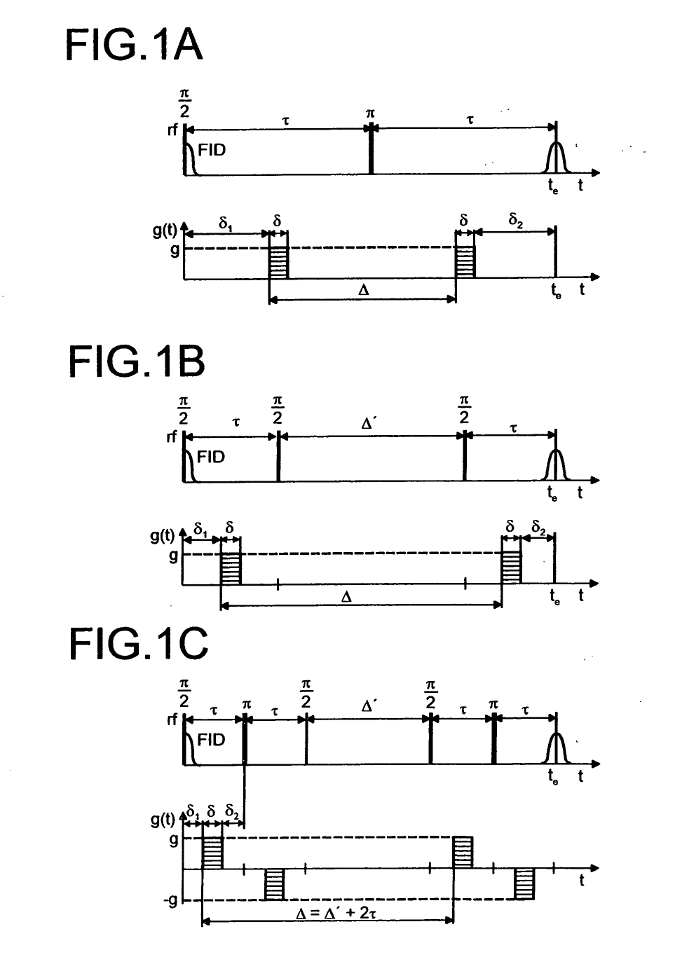

In PFG NMR, incidence of short high-frequency magnetic field pulses (HF pulses) initially generates a so-called spin echo of the nuclear spin. The intensity of this spin echo NMR signal is proportional to the number of resonant nuclear spins in the examination volume and is attenuated by spin-lattice (T₁) and spin-spin (T₂) relaxation processes from the time between the excitation by means of the first HF pulse up to the spin echo maximum (tₑ). FIG. 1 a-c shows, by way of example, three different pulse programs for the generation of such spin echo NMR signals. In the time intervals indicated by Δ′ of the pulse sequences b (stimulated spin echo, STE) and c (13-interval pulse sequence), the nuclear spins are subject to T₁ relaxation. During all other times and in pulse sequence a (Hahn spin echo, SE), they are subject only to T₂ relaxation.

For the measurement of the self-diffusion, during these pulse sequences, a location-dependent magnetic field of the form Bᵢₙₕ(Z)=gz is superimposed during short time intervals δ on the external magnetic field B₀, where g and z represent the pulsed magnetic field gradient and the location coordinate respectively. The necessary magnetic field gradient pulses are generated by means of current pulses synchronized to the HF pulse sequence, which flow through a suitable magnetic coil combination (the gradient coil). Because the resonance condition for nuclear spin during the duration of the field gradient pulses is location-dependent and the probe molecules diffuse to another location owing to self-diffusion between successive field gradient pulses, the amplitudes of the spin echo observed are attenuated. This spin echo attenuation ψ as a function of duration (δ), intensity (g) and the interval (Δ) of the magnetic field gradient is the quantity observed in PFG NMR. From this follows the self-diffusion coefficient D(Δ) of the molecules according to the equation (5)

$$Ψ ( g δ , Δ ) ≡ \frac{M ( g δ , Δ )}{M ( g δ = 0 , Δ )} = exp [ - b D ( Δ ) ] . \qquad ( 5 )$$

The parameter b depends upon the pulse sequence used. It is calculated from the measurement parameters of the particular PFG NMR pulse sequence. For the pulse sequence shown by way of example in FIG. 1, the quantity b is calculated to be:

$$b = {( γ δ g )}^{2} \times \{ \begin{matrix}( Δ - \frac{1}{3} δ ) & SE , STE \\ 4 ( Δ - \frac{1}{2} τ - \frac{1}{6} δ ) & 13 - Int .\end{matrix} \qquad ( 6 )$$

In this equation, γ represents the gyromagnetic ratio of the nuclear spin observed.

The term dependent upon the pulse sequence in the round brackets in Eq. (6) is the effective diffusion time. For short field gradient pulses, it is dominated by the time Δ, i.e. the interval of the field gradient pulses of the same polarity (FIG. 1) and is a variable parameter known from the pulse sequence in the PFG NMR experiment.

Experimentally, the spin echo attenuation curves are usually measured for a fixed interval Δ and a fixed duration δ of the field gradient pulses, and their intensity g is varied. The self-diffusion coefficient D(Δ) relative to the accompanying diffusion time Δ is calculated according to eq. (5) from the gradient of a plot of Inψ against—b. By means of the Einstein relationship, the mean quadratic shift during the diffusion time can be calculated from D(Δ) (equation 7): [symbol]
r²(Δ) [symbol] =6D(Δ)Δ (7)

The present invention also provides a process for determining the tortuosity of a catalyst support material by determining the self-diffusion D of a gas or of a liquid in the support material and the self-diffusion D₀ of the free gas or of the free liquid, in which, appropriately,
(i) a gas or a liquid comprising molecules having at least one atom with non-vanishing nuclear spin I (“probe molecules”) is introduced into the pore space of a sample of the support material,
(ii) an external magnetic field B₀ is generated at the location of the sample of the support material,
(iii) incidence of short high-frequency magnetic field pulses generates a spin echo of the nuclear spin I in the sample,
(iv) during several short time intervals δ, a location-dependent magnetic field B as a field gradient pulse is superimposed on the external magnetic field B₀, which attenuates the amplitude of the observed spin echo, and a spin echo attenuation ψ is thus measured as a function of the pulse duration δ, the intensity g and the time interval Δ of the field gradient pulses,
(v) the spin echo attenuation ψ is used to determine the self-diffusion coefficient D of the gas or liquid molecules in the sample,
(vi) steps (i) to (v) are carried out with a sample of the free gas or of the free liquid to determine a self-diffusion coefficient D₀ of the molecules of the free gas or of the free liquid,
(vii) the tortuosity characteristic τ is obtained as a quotient from the self-diffusion coefficient D₀ of the free gas or of the free liquid and the self-diffusion coefficient D of the gas or of the liquid in the support material τ=D₀/D.

A preferred probe liquid which is introduced in step (i) into the pore space of the sample of the support material, for example by impregnating the sample, is, as already mentioned, water. Alternatively, it is also possible to use liquids other than water as “probe molecules” for tortuosity measurement with PFG NMR. They merely have to have atoms having a nuclear spin detectable by NMR (e.g. ¹H, ¹⁹F, ¹³C) and to wet the porous support material, so that they are not spontaneously displaced from the pore space by air after the saturation procedure. Moreover, the vapor pressure of the wetted liquid should be high enough for the catalysts not to dry out during the NMR measurement, which can last for several hours. Suitable further liquids are, for example, cyclooctanes or other linear or cyclic alkanes having 5 or more carbon atoms. However, the tortuosity can also be determined with probe molecules present in gaseous form in the support material (for example propane, butane). When the selected probe molecule has access to the relevant pores, the result achieved is substantially independent of the selection of the probe molecule.

The inventive support consists generally of a (preferably thermally resistant) oxide or mixed oxide (e.g. steatite). It preferably comprises a metal oxide which is selected from the group consisting of zirconium dioxide, zinc oxide, aluminum oxide, silicon dioxide, titanium dioxide, magnesium oxide, lanthanum oxide, cerium oxide and mixtures thereof. The mixtures may be physical mixtures or else chemical mixed phases such as magnesium aluminum oxide mixed oxides or zinc aluminum oxide mixed oxides. The tortuosity of the metal oxides mentioned may vary to a very high degree. Among these, a support with suitable tortuosity is selected. However, the tortuosity may also be adjusted in a controlled manner by shaping (especially finely divided) nonoxidic or else already oxidic starting support materials (generally compounds comprising metals, which, on thermal treatment, decompose and are converted to metal oxides, at least on thermal treatment under air) in the presence of pore formers (for example by tableting or extruding), and subsequently treating them thermally.

In a preferred embodiment, the inventive dehydrogenation catalyst comprises at least one element of transition group VIII, at least one element of main group I and/or II, at least one element of main group III and/or IV and at least one element of transition group III including the lanthanides and actinides.

As element of transition group VIII, the active composition of the dehydrogenation catalysts preferably comprises platinum and/or palladium, more preferably platinum.

As an element of main group I and/or II, the active composition of the inventive dehydrogenation catalysts preferably comprises potassium and/or cesium.

As an element of transition group III including the lanthanides and actinides, the active composition of the inventive dehydrogenation catalysts preferably comprises lanthanum and/or cerium.

As an element of main group III and/or IV, the active composition of the inventive dehydrogenation catalysts preferably comprises one or more elements from the group consisting of boron, gallium, silicon, germanium, tin and lead, more preferably tin. The active composition of an inventive dehydrogenation catalyst most preferably comprises in each case at least one representative of the aforementioned element groups.

The catalytic hydrocarbon dehydrogenation may in principle be carried out in all reactor types and methods known from the prior art. A comparatively comprehensive description of dehydrogenation processes suitable in accordance with the invention is also present in “Catalyticae Studies Division, Oxidative Dehydrogenation and Alternative Dehydrogenation Processes” (Study Number 4192 OD, 1993, 430 Ferguson Drive, Mountain View, Calif. 94043-5272, USA).

A suitable reactor form is the fixed bed tubular reactor or tube bundle reactor. In these reactors, the catalyst (inventive dehydrogenation catalyst and, when working with oxygen as a cofeed, if appropriate specific oxidation catalyst) is disposed as a fixed bed in a reaction tube or in a bundle of reaction tubes. The reaction tubes are typically heated indirectly by combustion of a gas, for example a hydrocarbon such as methane, in the space surrounding the reaction tubes. It is favorable to apply this indirect form of heating only to the first approx. 20 to 30% of the length of the fixed bed and to heat the remaining bed length to the required reaction temperature by virtue of the radiative heat released in the course of the indirect heating. Typical reaction tube internal diameters are from about 10 to 15 cm. A typical dehydrogenation tube bundle reactor comprises from approx. 300 to 1000 reaction tubes. The temperature in the reaction tube interior varies typically within the range from 300 to 1200° C., preferably within the range from 500 to 1000° C. The working pressure is typically between 0.5 and 8 bar, frequently between 1 and 2 bar when a low steam dilution is used (corresponding to the Linde process for propane dehydrogenation), or else between 3 and 8 bar when a high steam dilution is used (corresponding to the so-called “steam active reforming process” (STAR process) for dehydrogenating propane or butane of Phillips Petroleum Co., see U.S. Pat. No. 4,902,849, U.S. Pat. No. 4,996,387 and U.S. Pat. No. 5,389,342). Typical gas hourly space velocities (GHSV) are from 500 to 2000 h⁻¹, based on hydrocarbon used. The catalyst geometry may, for example, be spherical or cylindrical (hollow or solid).

The nonoxidative catalytic hydrocarbon dehydrogenation may also, as described in Chem. Eng. Sci. 1992 b, 47 (9-11) 2313, be carried out under heterogeneous catalysis in a fluidized bed. In this case, two fluidized beds are appropriately operated alongside one another, of which one is generally in the state of regeneration. The working pressure is typically from 1 to 2 bar, the dehydrogenation temperature generally from 550 to 600° C. The heat required for the dehydrogenation is introduced into the reaction system by the dehydrogenation catalyst being preheated to the reaction temperature. The admixing of an oxygen-comprising cofeed allows the preheater to be dispensed with, and the heat required to be generated directly in the reactor system by combustion of hydrogen and/or hydrocarbons in the presence of oxygen. If appropriate, a hydrogen-comprising cofeed may additionally be admixed.

The nonoxidative catalytic hydrocarbon dehydrogenation may be carried out with or without oxygenous gas as a cofeed in a tray reactor. This comprises one or more successive catalyst beds. The number of catalyst beds may be from 1 to 20, appropriately from 1 to 6, preferably from 1 to 4 and in particular from 1 to 3. The catalyst beds are preferably flowed through radially or axially by the reaction gas. In general, such a tray reactor is operated with a fixed catalyst bed. In the simplest case, the fixed catalyst beds are arranged axially in a shaft furnace reactor or in the annular gaps of concentrically arranged cylindrical grids. A shaft furnace reactor corresponds to one tray. The performance of the dehydrogenation in a single shaft furnace reactor corresponds to a preferred embodiment, in which it is possible to work with oxygenous cofeed. In a further preferred embodiment, the dehydrogenation is carried out in a tray reactor with 3 catalyst beds. In a method without oxygenous gas as a cofeed, the reaction gas mixture in the tray reactor is subjected to intermediate heating on its way from one catalyst bed to the next catalyst bed, for example by passing it over heat exchanger surfaces heated with hot gases or by passing it through tubes heated with hot combustion gases.

In a preferred embodiment of the process according to the invention, the nonoxidative catalytic hydrocarbon dehydrogenation is carried out autothermally. To this end, oxygen is additionally admixed to the reaction gas mixture of the hydrocarbon dehydrogenation in at least one reaction zone and the hydrogen and/or hydrocarbon present in the reaction gas mixture is at least partly combusted, which generates at least some of the heat of dehydrogenation required in the at least one reaction zone directly in the reaction gas mixture. In general, the amount of the oxygenous gas added to the reaction gas mixture is selected such that the combustion of hydrogen present in the reaction gas mixture and, if appropriate, of hydrocarbons present in the reaction gas mixture and/or of carbon present in the form of coke generates the amount of heat required for the dehydrogenation of the hydrocarbon. In general, the total amount of oxygen supplied, based on the total amount of butane, is from 0.001 to 0.5 mol/mol, preferably from 0.005 to 0.2 mol/mol, more preferably from 0.05 to 0.2 mol/mol. Oxygen may be used either in the form of pure oxygen or in the form of an oxygenous gas in a mixture with inert gases, for example in the form of air. The inert gases and the resulting combustion gases generally additionally have a diluting action and thus promote the heterogeneous catalyzed dehydrogenation.

The hydrogen combusted for heat generation is the hydrogen formed in the catalytic hydrocarbon dehydrogenation and, if appropriate, hydrogen added additionally to the reaction gas mixture as a hydrogenous gas. Sufficient hydrogen should preferably be present that the molar H₂/O₂ ratio in the reaction gas mixture, immediately before the feeding of oxygen, is from 1 to 10 mol/mol, preferably from 2 to 5 mol/mol. In multistage reactors, this applies to each intermediate feeding of oxygenous and, if appropriate, hydrogenous gas.

The hydrogen is combusted catalytically. The dehydrogenation catalyst used generally also catalyzes the combustion of the hydrocarbons and of hydrogen with oxygen, so that in principle no specific oxidation catalyst other than it is required. One embodiment works in the presence of one or more oxidation catalysts which selectively catalyze the combustion of hydrogen with oxygen in the presence of hydrocarbons. As a result, the combustion of these hydrocarbons with oxygen to give CO, CO₂ and water only proceeds to a minor degree. The dehydrogenation catalyst and the oxidation catalyst are preferably present in different reaction zones.

In a multistage reaction, the oxidation catalyst may be present in only one reaction zone, or in a plurality of or in all reaction zones.

The catalyst which selectively catalyzes the oxidation of hydrogen is preferably arranged at the points at which there are higher partial oxygen pressures than at other points in the reactor, especially close to the feed point for the oxygenous gas. Oxygenous gas and/or hydrogenous gas may be fed in at one or more points in the reactor.

In one embodiment of the process according to the invention, oxygenous gas and hydrogenous gas are fed in intermediately upstream of each tray of a tray reactor. In a further embodiment of the process according to the invention, oxygenous gas and hydrogenous gas are fed in upstream of each tray except for the first tray. In one embodiment, a layer of a specific oxidation catalyst is present beyond each feed point, followed by a layer of a dehydrogenation catalyst. In a further embodiment, no specific oxidation catalyst is present. The dehydrogenation temperature is generally from 400 to 1100° C., the pressure in the last catalyst bed of the tray reactor generally from 0.2 to 5 bar, preferably from 1 to 3 bar. The GHSV is generally from 500 to 2000 h⁻¹, in high-load operation even up to 100 000 h⁻¹, preferably from 4000 to 16 000 h⁻¹.

A preferred catalyst which selectively catalyzes the combustion of hydrogen comprises oxides and/or phosphates selected from the group consisting of the oxides and/or phosphates of germanium, tin, lead, arsenic, antimony or bismuth. A further preferred catalyst which catalyzes the combustion of hydrogen comprises a noble metal of transition group VIII and/or I.

The hydrocarbon dehydrogenation is preferably carried out in the presence of steam. The added steam serves as a heat carrier and promotes the gasification of organic deposits on the catalysts, which counteracts the carbonization of the catalysts and increases the lifetime of the catalysts. This converts the organic deposits to carbon monoxide, carbon dioxide and, if appropriate, water.

Preferred C₂-C₃₀ hydrocarbons which are dehydrogenated in accordance with the invention are propane and butane.

The inventive dehydrogenation catalyst can be regenerated in a manner known per se. For instance, steam can be added to the reaction gas mixture or an oxygen-comprising gas can be passed over the catalyst bed at elevated temperature from time to time and the deposited carbon burnt off. The dilution with steam shifts the equilibrium toward the products of the dehydrogenation. If appropriate, the catalyst is reduced with a hydrogenous gas after the regeneration.

The process according to the invention is advantageous especially when the reaction gas mixture conducted over the dehydrogenation catalyst already comprises dehydrogenated hydrocarbon, as described in detail, for example, in the processes of the documents DE-A 102005009885, DE-A 102005022798, WO 01/96270, WO 01/96271, WO 03/011804, WO 03/76370, DE-A 10245585, DE-A 10246119, DE-A 10316039, DE-A 102004032129, DE-A 102005010111, DE-A 102005013039 and DE-A 102005009891. In all dehydrogenation processes mentioned in these documents, inventive catalysts are particularly suitable.

The invention is illustrated in detail by the examples which follow. The supports which follow are good catalyst supports particularly when the pore volume is in the range of 0.12-0.4 ml/g (measured by means of Hg porosimetry). The pore radius distribution may be unimodal, bimodal or polymodal.

The process according to the invention is particularly advantageous in that the determination of the tortuosity enables the selection of suitable supports and dehydrogenation catalysts in a very much simpler manner than in the past. In the past, complicated dehydrogenation experiments were always required for this purpose.

### EXAMPLES

### Examples 1 to 6

In the experiments described below, the following catalyst supports were used:

Preparation of a ZrO₂ Spray Powder:

A 500 l tank was initially charged with 72.6 kg of concentrated aqueous nitric acid (69% by weight of HNO₃), to which were added uniformly with stirring (20 rpm) within 2 h 58.7 kg of Zr(IV) carbonate (from MEL, Luxfer Group Company, approx. 43% by weight of ZrO₂). This gave a zirconyl nitrate solution having a content of approx. 19% by weight of ZrO₂ and a density of 1.59 kg/l. A stirred vessel (1000 l) was initially charged with 135.8 kg of aqueous ammonia (12.5% by weight of NH₃). The zirconyl nitrate solution was pumped into this uniformly with stirring within 2 h. The pH attained in the precipitation was 5.2 at 25° C. After continuing to stir for 6 h, the suspension was pumped in circulation on a filter press and washed with a total of 15 m³ of demineralized water over a period of 14 h until the conductivity of the washing water at 25° C. was below 20 μS/cm. 85.6 kg of moist filter paste were obtained. The filter paste was spread on metal sheets (layer height 10 cm) and dried under air in a chamber oven from Naber at 450° C. for 8 h under air. (Alternatively, the thermal treatment can also be carried out under H₂O vapor (1 bar). The resulting ZrO₂ powders can then be used appropriately in Examples 1-11 and the comparative example. Instead of a Naber oven, it is also possible to use a rotary tube oven through which air or steam is conducted in countercurrent to the dry material. The resulting ZrO₂ powders are then used analogously in Examples 1-11 and the comparative example.) The material had an ignition loss of 2.31% by weight under air at 900° C. The XRD analysis showed a content of 73% monoclinic and 27% tetragonal ZrO₂. Unless stated otherwise, the aforementioned steps were carried out at room temperature.

The ZrO₂ powder (particle diameter in the range of 0.3-100 μm, 50% by weight of the particles having a particle diameter of <10 μm was used to prepare the supports 1-6 according to Examples 1-6. The tortuosity data are each mean values from 2 measurements.

The pore diameter distribution determined by mercury porosimetry is displayed in the table below.

TABLE 1

| Pore diameter | Cumulative pore | Cumulative pore | Cumulative pore |
|---|---|---|---|
| [μm] | volume [ml/g] | volume [%] | surface [m²/g] |
| 300.00 | 0.0000 | 0.0000 | 0.0000 |
| 100.00 | 0.0063 | 2.8750 | 0.0000 |
| 50.00 | 0.0077 | 3.5169 | 0.0000 |
| 10.00 | 0.0090 | 4.1180 | 0.0000 |
| 5.00 | 0.0097 | 4.4486 | 0.001 |
| 1.00 | 0.0106 | 4.8296 | 0.002 |
| 0.50 | 0.0107 | 4.9130 | 0.003 |
| 0.10 | 0.0326 | 14.9174 | 0.462 |
| 0.05 | 0.0437 | 19.9744 | 1.119 |
| 0.01 | 0.2187 | 100.00 | 43.600 |

Instead of the polyethylene oxide having a molecular weight of from 2.5 to 3.0×10⁶ g/mol used in each case, it is also possible to use other polyethylene oxides having molecular weights within the range of 10⁸ 8×10⁶ g/mol. However, the use of the specified polyethylene oxides is particularly favorable for the inventive purposes.

### Example 1

3000 g of ZrO₂ powder were mixed in a pan grinder with 90 g of polyethylene oxide (Alkox® E 100, from KOWA American Corporation) and admixed with 90 g of concentrated aqueous nitric acid (69% by weight of HNO₃). To this were added 317 g of Silrese MSE 100 (from Wacker, 70% by weight of SiO₂ solution) and 500 ml of water. After pan-grinding for 5 minutes, a further 150 ml of water were added. After pan-grinding for a further 20 minutes at room temperature, the kneaded material was pressed in an extrudate press at a pressure of 280 bar to give extrudates having a diameter of 1.5 mm. After drying at 120° C. under air for 16 h, the extrudates were heat-treated at 560° C. under air for 4 h. The support thus obtained had a tortuosity of 2.15, measured with H₂O at 25° C. and pressure 1 bar.

### Example 2

3000 g of ZrO₂ powder were mixed with 120 g of polyethylene oxide (Alkox E 100, from KOWA American Corporation) in a pan grinder and admixed with 90 g of concentrated aqueous nitric acid (69% by weight of HNO₃). To this were added 350 g of Silres MSE 100 (from Wacker, 70% by weight of SiO₂ solution) and 500 ml of water. After pan-grinding for 5 minutes, a further 250 ml of water were added. After pan-grinding for a further 30 minutes at room temperature, the kneaded material was pressed in an extrudate press at a pressure of 280 bar to give extrudates having a diameter of 1.5 mm. After drying at 120° C. under air for 16 h, the extrudates were heat-treated at 600° C. under air for 4 h. The support thus obtained had a tortuosity of 2.55, measured with H₂O at 25° C. and pressure 1 bar.

### Example 3

3000 g of ZrO₂ powder were mixed in a pan grinder with 150 g of polyethylene oxide (Alkox E 100, from KOWA American Corporation) and admixed with 120 g of concentrated aqueous nitric acid (69% by weight of HNO₃). To this were added 500 g of Silres® MSE 100 (from Wacker, 70% by weight of SiO₂ solution) and 500 ml of water. After pan-grinding for 5 minutes, a further 250 ml of water were added. After pan-grinding for a further 30 minutes at room temperature, the kneaded material was pressed in an extrudate press at a pressure of 280 bar to give extrudates having a diameter of 1.5 mm. After drying at 120° C. under air for 16 h, the extrudates were heat-treated at 600° C. under air for 4 h. The support thus obtained had a tortuosity of 2.95, measured with H₂O at 25° C. and pressure 1 bar.

### Example 4

In a pan grinder, 3000 g of ZrO₂ powder were mixed with 100 g of cellulose ether (Optamixe AM 100, from Zschimmer & Schwarz GmbH & Co KG) and admixed with 120 g of concentrated aqueous nitric acid (69% by weight of HNO₃). To this were added 300 g of Silres MSE 100 (from Wacker, 70% by weight of SiO₂ solution) and 500 ml of water. After pan-grinding for 5 minutes, a further 250 ml of water were added. After pan-grinding for a further 30 minutes at room temperature, the kneaded material was pressed in an extrudate press at a pressure of 280 bar to give extrudates having a diameter of 1.5 mm. After drying at 120° C. under air for 16 h, the extrudates were heat-treated at 600° C. under air for 4 h. The support thus obtained had a tortuosity of 5.45, measured with H₂O at 25° C. and pressure 1 bar.

### Example 5

In a pan grinder, 3000 g of ZrO₂ powder were mixed with 150 g of polyethylene oxide (Alkox E 100, from KOWA American Corporation) and admixed with 120 g of concentrated aqueous nitric acid (69% by weight of HNO₃). To this were added 500 mg of Silres MSE 100 (from Wacker, 70% by weight of SiO₂ solution) and 500 ml of water. After pan-grinding for 5 minutes, a further 250 ml of water were added. After pan-grinding for a further 30 minutes at room temperature, the kneaded material was pressed in an extrudate press at a pressure of 280 bar to give extrudates having a diameter of 3 mm. After drying at 120° C. under air for 16 h, the extrudates were heat-treated at 600° C. under air for 4 h. The catalyst support was comminuted to spall to obtain a sieve fraction of 1.6-2 mm. The support thus obtained had a tortuosity of 2.8, measured with H₂O at 25° C. and pressure 1 bar.

### Example 6

3000 g of ZrO₂ powder were mixed in a pan grinder with 90 g of polyethylene oxide (Alkox E 100, from KOWA American Corporation) and admixed with 90 g of concentrated aqueous nitric acid (69% by weight of HNO₃). To this were added 317 g of Silres MSE 100 (from Wacker, 70% by weight of SiO₂ solution) and 500 ml of water. After pan-grinding for 5 minutes, a further 150 ml of water were added. After pan-grinding for a further 20 minutes at room temperature, the kneaded material was pressed in an extrudate press at a pressure of 280 bar to give extrudates having a diameter of 3 mm. After drying at 120° C. for 16 h, the extrudates were heat-treated at 560° C. under air for 4 h. The catalyst support was comminuted to spall to obtain a sieve fraction of 1.6-2 mm. The support thus obtained had a tortuosity of 2.3, measured with H₂O at 25° C. and pressure 1 bar.

Performance of the PFG NMR Self-Diffusion Analyses on the Water-Saturated Catalyst Supports 1-6:

The NMR analyses were effected at 25° C. and 1 bar at 125 MHz ¹H resonance frequency with the FEGRIS NT NMR spectrometer at the Faculty for Physics and Geological Sciences of the University of Leipzig. The pulse program used for the PFG NMR self-diffusion analyses was the stimulated spin echo with pulsed field gradients according to FIG. 1b. For each sample, the spin echo attenuation curves were measured at up to six different diffusion times (Δ/ms =20, 40, 80, 160, 240, 320) by stepwise increase in the intensity of the field gradients (gₘₐₓ=4 T/m). From the spin echo attenuation curves, the time dependence of the self-diffusion coefficient of the pore water was determined by means of equations (2) and (3).

Calculation of the Tortuosity:

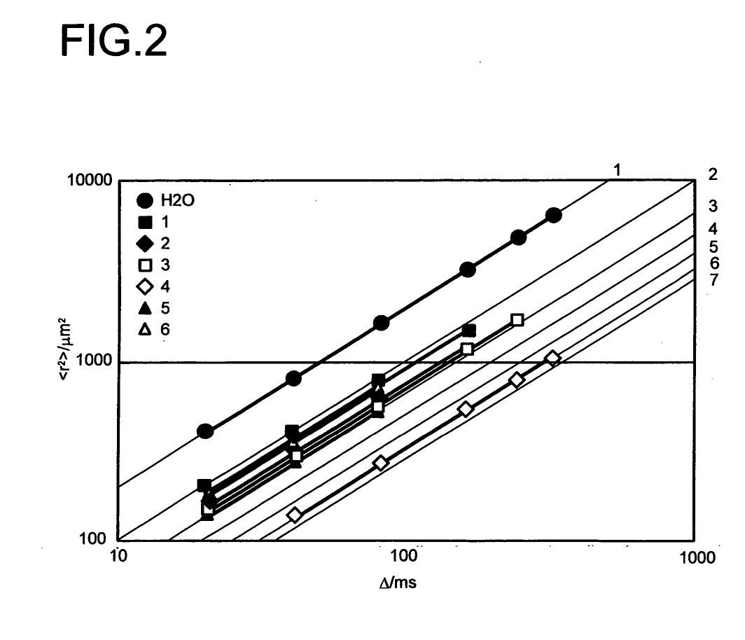

Equation (7) was used to calculate the time dependence of the mean quadratic shift [symbol] r²(Δ) [symbol] from the self-diffusion coefficients D(Δ) thus determined. In FIG. 2, these data for catalyst supports 1 to 7 are plotted in double logarithmic form together with the corresponding results for free water. FIG. 2 also shows in each case the best fit straight line from the linear fitting of [symbol] r²(Δ) [symbol] as a function of the diffusion time Δ. According to equation (7), its slope corresponds precisely to the value 6 D where D corresponds to the self-diffusion coefficient averaged over the diffusion time interval. According to equation (6), the tortuosity is then obtained from the ratio of the mean self-diffusion coefficient of free water thus determined to the corresponding value of the mean self-diffusion coefficient in the catalyst support.

The tortuosity values thus determined are summarized for catalyst supports 1-6 in Table 2, to independently prepare samples from the same batch having been analyzed per catalyst support.

TABLE 2

| Catalyst support | 1st analysis | 2nd analysis |
|---|---|---|
| Example | τ | τ |
| 1 | 2.2 ± 0.1 | 2.1 ± 0.1 |
| 2 | 2.6 ± 0.2 | 2.5 ± 0.2 |
| 3 | 2.8 ± 0.1 | 3.1 ± 0.1 |
| 4 | 4.9 ± 0.1 | 6.0 ± 0.1 |
| 5 | 2.6 ± 0.2 | 3.0 ± 0.2 |
| 6 | 2.4 ± 0.2 | 2.2 ± 0.2 |

### Examples 7 to 11 and Comparative Example C1

Preparation of Catalysts 1 to 6 Based on Catalyst Supports 1 to 6:

Catalyst supports 5 and 6 were comminuted to spall to obtain a sieve fraction of 1.6-2 mm. Catalyst supports 1-4 were used in the form of 1.5 mm extrudates (natural fracture). The support materials were coated with the active components Pt/Sn/K/Cs and La by the method described below:

0.1814 g of H₂PtCl₆.6H₂O and 0.2758 g of SnCl₂.2H₂O were dissolved in 138 ml of ethanol and added at 25° C. to 23 g of the support material in a rotary evaporator. The supernatant ethanol was removed on the rotary evaporator with rotation in a water-jet pump vacuum (20 mbar) at a water bath temperature of 40° C. Subsequently, in each case under stationary air, the solids were first dried at 100° C. for 15 h and then calcined at 560° C. (under stationary air) over 3 h. Thereafter, a solution of 0.1773 g of CsNO₃, 0.3127 g of KNO₃ and 2.2616 g of La(NO₃)₃.6H₂O in 55 ml of H₂O at 25° C. was poured over the dried solid. The supernatant water was removed on a Rotavapor with rotation in a water-jet pump vacuum (20 mbar) at a water bath temperature of 85° C. Subsequently, in each case under stationary air, the solid was dried at 100° C. for 15 h and then calcined at 560° C. under stationary air for 3 h.

Catalysts 1-6 were thus obtained from catalyst supports 1-6. The catalysts thus obtained were installed into a test reactor and activated.

Catalyst Activation:

20 ml of the resulting catalyst precursor in each case were used to charge a vertical tubular reactor.

Reactor length: 520 mm;

Wall thickness: 2 mm;

Internal diameter: 20 mm;

Reactor material: internally alonized, i.e. aluminum oxide-coated, steel tube;

Heating: electrical along a centered length of 450 mm;

Length of the catalyst bed: 60 mm;

Position of the catalyst bed: centered;

Charging of the remaining reactor volume above and below with steatite spheres of diameter of 4-5 mm as inert material, resting at the bottom on a catalyst base.

Subsequently, the reaction tube was charged with 9.3 l (STP)/h of hydrogen at an outer wall temperature along the heating zone of 500° C. for 30 min. Subsequently, the hydrogen stream, at constant wall temperature, was replaced first by a stream of 23.6 l (STP)/h of 80% by volume of nitrogen and 20% by volume of air for 30 min and then by a pure air stream of equal size for a further 30 min. While maintaining the wall temperature, flushing was then effected with an N₂ stream of equal size for 15 min and final reduction with 9.3 l (STP)/h of hydrogen for another 30 min. The activation of the catalyst precursor was then complete.

Catalyst Testing:

After the activation, the catalysts were tested by contacting them in the same reactor with a mixture of 20 l (STP)/h of crude propane, 18 g/h of steam and 1 l (STP)/h of nitrogen. To this end, crude propane was metered in by means of a mass flow regulator, while water was metered by means of an HPLC pump initially in liquid form into an evaporator, evaporated therein and then mixed with the crude propane and nitrogen. The gas mixture was passed over the catalyst. The wall temperature was 622° C.

By means of a pressure regulator disposed at the reactor outlet, the outlet pressure of the reactor was adjusted to 1.5 bar absolute.

The product gas decompressed to standard pressure beyond the pressure regulator was cooled, which condensed out the steam present. The uncondensed residual gas was analyzed by means of GC (HP 6890 with Chem-Station, detectors: FID, TCD, separating columns: Al₂O₃/KCl (Chrompak), carboxen 1010 (Supelco)). The reaction gas [starting gas stream] had also been analyzed in a corresponding manner.

Table 3 summarizes, for catalysts 1-6, the averaged tortuosity, the BET surface area determined by means of N₂ adsorption, the activity (based on the propane conversion) and the deactivation of the catalyst.

TABLE 3

| | | | | | De- |
|---|---|---|---|---|---|
| | | | BET | | activa- |
| | | | surface | Starting | tion |
| Example | Catalyst | Tortuosity | area | conversion | [mol |
| (catalyst) | geometry | τ | [m²/g] | [mol %] | %/h] |
| 7 (1) | 1.5 mm extrudate | 2.15 | 70 | 44.7 | 0.05 |
| 8 (2) | 1.5 mm extrudate | 2.55 | 58 | 42.5 | 0.09 |
| 9 (3) | 1.5 mm extrudate | 2.95 | 69 | 44.9 | 0.06 |
| C1 (4) | 1.5 mm extrudate | 5.45 | 83 | 43.8 | 1.12 |
| 10 (5) | 1.6-2 mm spall | 2.8 | 69 | 48.1 | 0.27 |
| 11 (6) | 1.6-2 mm spall | 2.3 | 66 | 47.0 | 0.13 |

The deactivation of the catalyst correlates with the averaged tortuosity (T). The inner surface area of the catalyst (BET surface area) correlates neither with the tortuosity nor with the deactivation. The conversion reported is the propane conversion at the start of the dehydrogenation experiment; the decline in conversion in % per hour is a measure of the deactivation of the catalyst. As can be taken from the examples, the inventive catalysts have very much lower deactivation compared to the comparative catalyst with substantially comparable BET surface area.

What is claimed is:

1. A process for determining the tortuosity of a porous catalyst support material by determining the self-diffusion D of a gas or of a liquid in the support material and the self-diffusion D₀ of the free gas or of the free liquid and calculating the quotient D/D₀.

2. The process according to claim 1, wherein
(i) a gas or a liquid comprising molecules having at least one atom with non-vanishing nuclear spin I is introduced into the pore space of a sample of the support material,
(ii) an external magnetic field B₀ is generated at the location of the sample of the support material,
(iii) incidence of short high-frequency magnetic field pulses generates a spin echo of the nuclear spin I in the sample,
(iv) during several short time intervals δ, a location-dependent magnetic field B as a field gradient pulse is superimposed on the external magnetic field B₀, which attenuates the amplitude of the observed spin echo, and a spin echo attenuation ψ is thus measured as a function of the pulse duration δ, the intensity g and the time interval Δ of the field gradient pulses,
(v) the spin echo attenuation ψ is used to determine the self-diffusion coefficient D of the gas or liquid particles in the sample,
(vi) steps (i) to (v) are carried out with a sample of the free gas or of the free liquid to determine a self-diffusion coefficient D₀ of the free gas or of the free liquid,
(vii) the tortuosity characteristic τ is obtained as a quotient from the self-diffusion coefficient D₀ of the molecules of the free gas or of the free liquid and the self-diffusion coefficient D of the molecules of the gas or of the liquid in the support material τ=D₀/D.

3. The process according to claim 2, wherein the gas or the liquid which is introduced in step (i) into the pore space of a sample of the support material is water.

4. A catalyst support composed of a porous support material having a tortuosity characteristic τ of from 1.5 to 4.

5. The catalyst support according to claim 4, composed of a porous support material having a tortuosity characteristic τ of from 1.5 to 3.

6. The catalyst support according to claim 5, composed of a porous support material having a tortuosity characteristic τ of from 2 to 3.

7. The catalyst support according to any of claims 4-6, wherein the support material comprises a metal oxide selected from the group consisting of zirconium dioxide, aluminum oxide, silicon dioxide, titanium dioxide, magnesium oxide, lanthanum oxide and cerium oxide.

8. A dehydrogenation catalyst having improved deactivation behavior, comprising one or more active metals in elemental form and/or oxidic form on a catalyst support according to any of claims 4 to 7.

9. The dehydrogenation catalyst according to claim 8, which comprises at least one element of transition group VIII, at least one element of main group I or II, at least one element of main group III or IV and at least one element of transition group III, including the lanthanides and actinides, in elemental form and/or oxidic form, on the catalyst support.

10. The dehydrogenation catalyst according to claim 8 or 9, which comprises platinum and/or palladium in elemental form.

11. The dehydrogenation catalyst according to any of claims 8 to 10, which comprises cesium and/or potassium in oxidic form.

12. The dehydrogenation catalyst according to any of claims 8 to 11, which comprises lanthanum and/or cerium in oxidic form.

13. The dehydrogenation catalyst according to any of claims 8 to 12, which comprises tin.

14. A dehydrogenation catalyst consisting of a porous support body and an active composition applied thereto, which has a tortuosity characteristic τ of from 1.5 to 4.

15. A process for heterogeneously catalyzed dehydrogenation of one or more dehydrogenatable C₂-C₃₀ hydrocarbons in a reaction gas mixture which comprises them, which comprises contacting the reaction gas mixture which comprises the dehydrogenatable hydrocarbon(s) with a dehydrogenation catalyst according to any of claims 8 to 14.

16. The process according to claim 15, wherein the dehydrogenation is carried out autothermally by at least some of the heat of dehydrogenation required being generated directly in the reaction gas mixture in at least one reaction zone by combusting hydrogen, the reactant and/or product hydrocarbon(s) and/or carbon in the presence of an oxygenous gas.

17. The process according to claim 15 or 16, wherein the dehydrogenatable hydrocarbon is propane and/or butane.

18. The process according to claim 15 or 17, wherein the starting reaction gas mixture already comprises dehydrogenated hydrocarbon.

19. A process for determining the tortuosity of a catalyst comprising a porous support material and an active composition applied thereto by determining the self-diffusion D of a gas or of a liquid in the catalyst and the self-diffusion D₀ of the free gas or of the free liquid and calculating the quotient D/D₀.

20. The process according to claim 19, wherein
(i) a gas or a liquid comprising molecules having at least one atom with non-vanishing nuclear spin I is introduced into the pore space of a sample of the catalyst,
(ii) an external magnetic field B₀ is generated at the location of the sample of the catalyst,
(iii) incidence of short high-frequency magnetic field pulses generates a spin echo of the nuclear spin I in the sample,
(iv) during several short time intervals δ, a location-dependent magnetic field B as a field gradient pulse is superimposed on the external magnetic field B₀, which attenuates the amplitude of the observed spin echo, and a spin echo attenuation ψ is thus measured as a function of the pulse duration δ, the intensity g and the time interval Δ of the field gradient pulses,
(v) the spin echo attenuation ψ is used to determine the self-diffusion coefficient D of the gas or liquid particles in the sample,
(vi) step (i) to (v) is carried out with a sample of the free gas or of the free liquid to determine a self-diffusion coefficient D₀ of the free gas or of the free liquid,
(vii) the tortuosity characteristic τ is obtained as a quotient from the self-diffusion coefficient D₀ of the molecules of the free gas or of the free liquid and the self-diffusion coefficient D of the molecules of the gas or of the liquid in the support material τ=D₀/D.

21. The process according to claim 20, wherein the gas or the liquid which is introduced in step (i) into the pore space of a sample of the catalyst is water.

22. A catalyst comprising a porous support material and an active composition applied thereto, having a tortuosity characteristic τ of from 1.5 to 4.

23. The catalyst according to claim 22, comprising a porous support material and an active composition applied thereto, having a tortuosity characteristic τ of from 1.5 to 3.

24. The catalyst according to claim 23, comprising a support material and an active composition applied thereto, having a tortuosity characteristic τ of from 2 to 3.

25. The catalyst according to any of claims 22-24, wherein the support material comprises a metal oxide selected from the group consisting of zirconium dioxide, aluminum oxide, silicon dioxide, titanium dioxide, magnesium oxide, lanthanum oxide and cerium oxide.
